(19) United States
(12) Patent Application Publication
(10) Pub. No.: US 2021/0037819 A1
(43) Pub. Date: Feb. 11, 2021

(54) HERBICIDE COMPOSITION CONTAINING PYRIMIDINEDIONE-BASED COMPOUND

(71) Applicant: FARMHANNONG CO., LTD., Seoul (KR)

(72) Inventors: Jung Kook EOM, Daejeon (KR); Jun Hyuk CHOI, Daejeon (KR); Tae Hyun OH, Daejeon (KR); Sung Hwan KIM, Daejeon (KR); Yong Oh JANG, Daejeon (KR); Tae Joon KIM, Daejeon (KR)

(73) Assignee: FARMHANNONG CO., LTD., Seoul (KR)

(21) Appl. No.: 16/967,032

(22) PCT Filed: Mar. 5, 2019
(86) PCT No.: PCT/KR2019/002536

§ 371 Date: Aug. 3, 2020

(30) Foreign Application Priority Data
Mar. 6, 2018 (KR) 10-2018-0026316

(51) Int. Cl. A01N 25/24; A01N 43/54; A01N 57/20; A01N 25/30

(52) U.S. Cl. CPC A01N 25/24; A01N 25/30; A01N 57/20; A01N 43/54

(57) ABSTRACT

Disclosed is an herbicidal composition containing: a pyrimidinedione-based compound as an active ingredient; and an efficacy enhancer. The herbicidal composition can increase biological effect expression characteristics of the pyrimidinedione-based composition as a contact herbicide, improve fast-acting property on monocot weeds as well as broadleaf weeds through enhanced spreading ability and penetrating power, and effectively control, at a low dose, even resistant weeds showing resistance to other herbicides. Furthermore, the herbicidal composition retains thermodynamic stability to increase storage stability, and can exhibit uniform and excellent efficacy at the time of chemical treatment through the uniform dispersion of the active ingredient.

### BACKGROUND OF THE INVENTION

### 1. Field of the Invention

The present disclosure relates to an herbicidal composition containing a pyrimidinedione-based compound.

### 2. Description of the Prior Art

The control of weeds has played a very important role in productivity increase and labor reduction in agriculture, and various kinds of herbicides have been used so far. Out of these, representative non-selective herbicides are paraquat SL formulations, glyphosate SL formulations, glufosinate SL formulations, and the like. However, the sale of paraquat SL formulations was prohibited in Korea due to fatal toxicity to humans and domestic animals; glyphosate SL formulations have the problem of carcinogenic potency, and have a difficulty in controlling weeds due to the occurrence of herbicide-resistant weeds; and glyphosate SL formulations, which are non-selective herbicides in orchards and non-farmland, cannot control some grass species, and are used in high doses in order to control lots of problematic weeds. Therefore, the development of high-functional herbicides capable of solving all of the problems is required.

There have been developments of pyrimidinedione-based compounds capable of solving the problems of these existing non-selective herbicides, such as toxicity to humans and domestic animals, the occurrence of herbicide-resistant weeds, and high-dose treatment. The pyrimidinedione-based compounds have an effect of killing a contact portion when herbicides are in contact with leaves or stems of weeds. However, these compounds have almost no penetration transferability, and have somewhat low activity on weeds with low chlorophyll, tissues of weeds, and Gramineae family weeds. In order to overcome such disadvantages, an efficacy enhancing composition for increasing herbicidal activity and quickening speed of biological action of contact herbicides and reducing doses thereof needs to be developed.

### SUMMARY OF THE INVENTION

The present disclosure has been made in order to solve the above-mentioned problems in the prior art and an aspect of the present disclosure is to develop an optimal efficacy enhancer capable of quickening speed of herbicidal effects and reducing doses in the use of a pyrimidinedione-based compound as an herbicide, thereby notably increasing the utilization as an herbicide, and to provide an herbicidal composition containing an efficacy enhancer.

Another aspect of the present disclosure is to provide herbicidal compositions of various formulations containing a pyrimidinedione-based compound having favorable physical and chemical properties and ensuring product stability.

In accordance with an aspect of the present disclosure, there is provided an herbicidal composition. The herbicidal composition contains: an herbicidally active compound including a pyrimidinedione-based compound; and an efficacy enhancer for the herbicidally active compound, wherein the efficacy enhancer is selected from the group consisting of: Alcohols, C₁₂₋₁₄ ethoxylated; Alcohols C₉₋₁₁ ethoxylated propoxylated; a mixture of 1-dodecanaminium, N-(carboxymethyl)-N,N-dimethyl-, inner salt, 1-tetradecanaminium, N-(carboxymethyl)-N,N-dimethyl-, inner salt, glycerine, and water; propylene oxide ethylene oxide polymer octyl ether; organosilicone ethoxylates; polyoxyethylene polyoxypropylene block copolymer; polyoxyethylene alkyl ether; polyoxyethylene polyoxypropylene alkylethers; fatty amine ethoxylates; oxirane, methyl-, polymer with oxirane, mono(2-propylheptyl) ether; quaternary ammonium salt; sodium alkyl sulfosuccinates; polyoxyethylene sorbitanalkylester compounds; methylated soybean oil compounds; ethyl and methyl esters of canola oil; crop oil concentrates; and a combination thereof.

According to the present disclosure, the pyrimidinedione-based compound may be selected from the group consisting of butafenacil, saflufenacil, tiafenacil, benzfedizone, and a combination thereof.

According to the present disclosure, the herbicidally active compound may further include at least one selected from the group consisting of glyphosate and glufosinate.

According to the present disclosure, the herbicidal composition may further contain a surfactant, a solvent, an antifoamer, an antifreezing agent, a thickener, a filler, a pH adjuster, or a preservative.

According to the present disclosure, the surfactant may be selected from the group consisting of: castor oil, ethoxylates; polyoxyethylene tristyrylphenyl ether; ethoxylated fatty alcohol; alkylphenol ethoxylates; ethylene oxide/propylene oxide block copolymer (EO/PO block copolymer); a blend of dodecylbenzenesulfonic acid, calcium salt, and castor oil ethoxylates; polyethylene-polypropylene glycol, monobutyl ether; Alcohols, C₁₂₋₁₅, ethoxylated; methyl methacrylate-methacrylic acid-monomethoxypolyethylene glycol methacrylate copolymer; polyoxyalkylene amine derivative; polyoxyethylene tristyrylphenol phosphate, potassium salt; triethanolamine, compd. with polyoxyethylene) tristyrylphenyl ether; methacrylic acid-methyl methacrylate-polyethylene glycol methyl ether methacrylate copolymer; naphthalenesulfonic acid, polymer with formaldehyde, sodium salt; nonylphenol, ethoxylated, monoether with sulfuric acid, sodium salt; sodium bis(2-ethylhexyl) sulfosuccinate; polyoxyethylene-polyoxypropylene copolymer; [alpha]-D-glucopyranoside, 2-ethylhexyl; phenolsulfonic acid formaldehyde phenol urea polymer, sodium salt; diisobutylnaphthalenesulfonic acid, sodium salt; sucrose monolaurate; poly(oxy-1,2-ethanediyl), alpha-tris(1-phenylethyl)phenyl-omega-hydroxy-phosphate, potassium salt; polyaminoamide alkoxylated condensates; phosphoric acid esters of polyethoxylated tristyryl and distyrylphenol; 2-propenoic acid, 2-methyl-, polymer with butyl 2-propenoate and ethenylbenzene, sodium salt; sulfonic acids, C14-16-alkane hydroxy and C14-16-alkene, sodium salts; lignosulfonic acid, sodium salt; sulfuric acid, disodium salt; acrylic acid polymer, sodium salt; dodecyl sulfate, sodium salt; urea-formaldehyde resin; polyethylene glycol mono(tristyrylphenyl)ether; dodecylbenzenesulfonic acid, calcium salt; sodium stearate; and a combination thereof.

According to the present disclosure, the solvent is selected from the group consisting of gamma-butyrolactone; N,N-dimethyl decanamide; dimethyl sulfoxide; butyl benzoate; 2-ethylhexyl maleate; 2-ethylhexyl alcohol; propylene carbonate; solvent naphtha (petroleum), heavy aromatic; cyclohexanone; propylene glycol cyclic carbonate; acetophenone; 2-ethylhexyl acetate; lactic acid, ethyl ester; tetrahydrofurfuryl acrylate; and a combination thereof.

According to the present disclosure, the antifoamer may be selected from the group consisting of silicones and siloxanes, dimethyl; siloxanes and silicones, di-Me reaction products with silica; and a combination thereof.

According to the present disclosure, the thickener may be selected from the group consisting of smectite-group minerals; silicon dioxide; magnesium oxide; Fuller's earth; xanthan gum; carboxymethyl cellulose; cellulose, 2-hydroxyethyl ether; gum arabic; acrylic acid polymer; and a combination thereof.

According to the present disclosure, the filler may be selected from the group consisting of potassium chloride; diatomaceous earth, flux-calcined; diatomaceous earth, calcined; kaolin; bentonite; urea; talc; diatomaceous earth (less than 1% crystalline silica); water; and a combination thereof.

According to the present disclosure, the pH adjuster may be selected from the group consisting of sodium hydroxide; potassium hydroxide; phosphoric acid; citric acid; EDTA-acid; and a combination thereof.

According to the present disclosure, the antifreezing agent may be selected from the group consisting of propylene glycol; ethylene glycol; glycerine; 2,3-butandiol; and a combination thereof.

According to the present disclosure, the preservative may be selected from the group consisting of 3(2H)-isothiazolone, 5-chloro-2-methyl; 3(2H)-isothiazolone, 2-methyl; 1,2-benzisothiazolin-3-one; and a combination thereof.

According to the present disclosure, the efficacy enhancer may be contained in an amount of 3-20 wt % on the basis of 100 wt % of the entire composition.

According to the present disclosure, the herbicidal composition may be in a formulation of a wettable powder (WP), an emulsifiable concentrate (EC), Emulsions, oil in water (EN), a Microemulsion (ME), a Soluble concentrate (SL), Water-dispersible granule (WG), or a Suspension concentrate (SC).

In accordance with an aspect of the present disclosure, there is provided an herbicidal composition. The herbicidal composition contains an herbicidally active compound comprising tiafenacil; and an efficacy enhancer comprising, on the basis of 100 wt % of the entire composition, 14-20 wt % of Alcohols, C₁₂₋₁₄ ethoxylated or Alcohols, C₉₋₁₁ ethoxylated propoxylated.

In accordance with an aspect of the present disclosure, there is provided an herbicidal composition. The herbicidal composition contains: an herbicidally active compound comprising tiafenacil and glufosinate; and an efficacy enhancer comprising, on the basis of 100 wt % of the entire composition, 3-7 wt % of Alcohols, C₁₂₋₁₄ ethoxylated or Alcohols, C₉₋₁₁ ethoxylated propoxylated.

In accordance with an aspect of the present disclosure, there is provided an herbicidal composition. The herbicidal composition contains: an herbicidally active compound comprising tiafenacil and glyphosate; and 3-7 wt % of an efficacy enhancer on the basis of 100 wt % of the entire composition, wherein the efficacy enhancer comprises a mixture of 1-dodecanaminium, N-(carboxymethyl)-N,N-dimethyl-, inner salt, 1-tetradecanaminium, N-(carboxymethyl)-N,N-dimethyl-, inner salt, glycerine, and water.

The herbicidal composition of the present disclosure can enhance biological effects thereof by containing an efficacy enhancer capable of increasing the herbicidal effect of a pyrimidinedione-based compound as an active ingredient by 20% or more compared with an active substance. The herbicidal composition can induce fast penetration of chemicals into weeds, thereby significantly improving biological activity of herbicides.

Furthermore, the herbicidal composition of the present disclosure can retain significantly enhanced spreading strength on broad-leaf weeds and show an improved control value on even monocot weeds through enhanced spreading ability and penetrating power.

Furthermore, the present inventors ensured a prescription that the herbicidal composition contains an efficacy enhancer so as to express efficacy as various formulations, such as a microemulsion, a suspension concentrate, and water-dispersible granules, and retains storage stability to maintain a stable state for three years or longer. In addition, the active ingredient may be homogeneously dispersed in a diluted liquid to exhibit an uniform and excellent efficacy at the time of herbicide treatment.

The herbicidal composition of the present disclosure can effectively control, at a low dose, even resistant weeds, recently generated due to repetitive use of existing herbicides, such as glyphosate herbicides.

### DETAILED DESCRIPTION OF THE EXEMPLARY EMBODIMENTS

The present disclosure provides an herbicidal composition contains: an herbicidally active compound including a pyrimidinedione-based compound; and an efficacy enhancer for the herbicidally active compound.

In the present disclosure, the pyrimidinedione-based compound is a substance corresponding to an active ingredient, and refers to a series of compounds having a pyrimidinedione structure at a head part, among the substances that suppress an enzymatic action of protoporphyrinogen oxidase in plants to show herbicidal activity. Protoporphyrinogen oxidase inhibitors may be largely classified into diphenyl-ethers, phenylpyrazoles, N-phenylphthalimides, thiadiazoles, oxadiazoles, triazolinones, oxizolidinediones, pyrimimdinediones, and the like, according to structural similarity of compounds. Specifically, diphenyl-ether-based compounds include fomesafen, oxyfluorfen, aclonifen, acifluophen, bifenox, ethoxyphen, and lactofen; phenylpirazole-based compounds include pyraflufen-ethyl; N-phenylphthalimide-based compounds include flumioxazin, cinidon-ethyl, and flumiclorac-pentyl; and thiadiazole-based compounds include fluthiacet. As representative examples, oxadiazole-based compounds include oxadiazyl and oxadiazon; triazolinone-based compounds include carfentrazone and sulfentrazone; and oxazolidinedione-based compounds include pentoxazone.

The pyrimidinedione-based compound of the present disclosure may be selected from the group consisting of butafenacil, saflufenacil, tiafenacil, benzfedizone, flumioxazine, and a combination thereof.

Also, the herbicidally active compound of the present disclosure may further include glyphosate or glufosinate besides the pyrimidinedione-based compound.

In the present disclosure, the efficacy enhancer refers to any substance that may be contained in the herbicidal composition in order to allow a pyrimidinedione-based compound as an active ingredient to easily penetrate into a site of action of weeds, thereby enhancing efficacy of the pyrimidinedione-based compound, but does not refer to the pyrimidinedione-based compound.

The efficacy enhancer may be selected from the group consisting of: Alcohols, C₁₂₋₁₄ ethoxylated; Alcohols C₉₋₁₁ ethoxylated propoxylated; a mixture of 1-dodecanaminium, N-(carboxymethyl)-N,N-dimethyl-, inner salt, 1-tetradecanaminium, N-(carboxymethyl)-N,N-dimethyl-, inner salt, glycerine, and water; propylene oxide ethylene oxide polymer octyl ether; organosilicone ethoxylates; polyoxyethylene polyoxypropylene block copolymer; polyoxyethylene alkyl ether; polyoxyethylene polyoxypropylene alkylethers; fatty amine ethoxylates; oxirane, methyl-, polymer with oxirane, mono(2-propylheptyl) ether; quaternary ammonium salt; sodium alkyl sulfosuccinates; polyoxyethylene sorbitanalkylester compounds; methylated soybean oil compounds; ethyl and methyl esters of canola oil; crop oil concentrates; and a combination thereof.

The efficacy enhancer of the present disclosure may be contained in an amount of 3-20 wt % on the basis of 100 wt % of the entire composition.

The herbicidal composition of the present disclosure may further contain a surfactant and a solvent.

The surfactant may be selected from the group consisting of: castor oil, ethoxylates; polyoxyethylene tristyrylphenyl ether; ethoxylated fatty alcohol; alkylphenol ethoxylates; ethylene oxide/propylene oxide block copolymer (EO/PO block copolymer); a blend of dodecylbenzenesulfonic acid, calcium salt, and castor oil ethoxylates; polyethylene-polypropylene glycol, monobutyl ether; Alcohols, C₁₂₋₁₅, ethoxylated; methyl methacrylate-methacrylic acid-monomethoxypolyethylene glycol methacrylate copolymer; polyoxyalkylene amine derivative; polyoxyethylene tristyrylphenol phosphate, potassium salt; triethanolamine, compd. with polyoxyethylene) tristyrylphenyl ether; methacrylic acid-methyl methacrylate-polyethylene glycol methyl ether methacrylate copolymer; naphthalenesulfonic acid, polymer with formaldehyde, sodium salt; nonylphenol, ethoxylated, monoether with sulfuric acid, sodium salt; sodium bis(2-ethylhexyl) sulfosuccinate; polyoxyethylene-polyoxypropylene copolymer; [alpha]-D-glucopyranoside, 2-ethylhexyl; phenolsulfonic acid formaldehyde phenol urea polymer, sodium salt; diisobutylnaphthalenesulfonic acid, sodium salt; sucrose monolaurate; poly(oxy-1,2-ethanediyl), alpha-tris(1-phenylethyl)phenyl-omega-hydroxy-phosphate, potassium salt; polyaminoamide alkoxylated condensates; phosphoric acid esters of polyethoxylated tristyryl and distyrylphenol; 2-propenoic acid, 2-methyl-, polymer with butyl 2-propenoate and ethenylbenzene, sodium salt; sulfonic acids, C14-16-alkane hydroxy and C14-16-alkene, sodium salts; lignosulfonic acid, sodium salt; sulfuric acid, disodium salt; acrylic acid polymer, sodium salt; dodecyl sulfate, sodium salt; urea-formaldehyde resin; polyethylene glycol mono(tristyrylphenyl)ether; dodecylbenzenesulfonic acid, calcium salt; sodium stearate; and a combination thereof.

The solvent may be selected from the group consisting of gamma-butyrolactone; N,N-dimethyl decanamide; dimethyl sulfoxide; butyl benzoate; 2-ethylhexyl maleate; 2-ethylhexyl alcohol; propylene carbonate; solvent naphtha (petroleum), heavy aromatic; cyclohexanone; propylene glycol cyclic carbonate; acetophenone; 2-ethylhexyl acetate; lactic acid, ethyl ester; tetrahydrofurfuryl acrylate; and a combination thereof.

In an embodiment, the antifoamer may be selected from the group consisting of silicones and siloxanes, dimethyl; siloxanes and silicones, di-Me reaction products with silica; and a combination thereof.

In an embodiment of the present disclosure, the thickener may be selected from the group consisting of smectite-group minerals; silicon dioxide; magnesium oxide; Fuller's earth; xanthan gum; carboxymethyl cellulose; cellulose, 2-hydroxyethyl ether; gum arabic; acrylic acid polymer; and a combination thereof.

In an embodiment of the present disclosure, the filler may be selected from the group consisting of potassium chloride; diatomaceous earth, flux-calcined; diatomaceous earth, calcined; kaolin; bentonite; urea; talc; diatomaceous earth (less than 1% crystalline silica); water; and a combination thereof.

In an embodiment of the present disclosure, the pH adjuster may be selected from the group consisting of sodium hydroxide; potassium hydroxide; phosphoric acid; citric acid; EDTA-acid; and a combination thereof.

In an embodiment of the present disclosure, the antifreezing agent may be selected from the group consisting of propylene glycol; ethylene glycol; glycerine; 2,3-butandiol; and a combination thereof.

In an embodiment of the present disclosure, the preservative may be selected from the group consisting of 3(2H)-isothiazolone, 5-chloro-2-methyl; 3(2H)-isothiazolone, 2-methyl; 1,2-benzisothiazolin-3-one; and a combination thereof.

The present disclosure can provide an herbicidal composition as a microemulsion formulation (ME), a suspension concentrate formulation (SC), or a water-dispersible granule formulation (WG), the herbicidal composition containing the pyrimidinedione-based compound, the efficacy enhancer, and the surfactant.

The microemulsion, which is a mixed system of water, oil and surfactant, is an isotropic and thermodynamically stable liquid mixture. Since the oil component is present as oil-in-water (O/W) or water-in-oil (W/O) type swollen micelle form, a physically stable mixed composition can be ensured while an efficacy enhancer is added according to the design of prescription. In addition, the microemulsion is a transparent liquid formulation having micro-sized dispersed emulsions and retaining extremely low surface tension, and thus has excellent penetration transferability, and thus a synergistic effect of optimizing biological activity can be expected.

The microemulsion formulation according to the present disclosure can improve biological effect expression characteristics of the pyrimidinedione-based compound as a contact herbicide, improve fast-acting property on monocot weeds as well as broad leaf weeds through enhanced spreading ability and penetrating power, and effectively control, at a low dose, even multiple herbicide resistant weeds. In addition, the microemulsion formulation retains thermodynamic stability to increase storage stability, and can exhibit uniform and excellent efficacy at the time of chemical treatment through the uniform dilution dispersion stability of the pyrimidinedione-based compound as an active ingredient.

The present disclosure also provides a method for preparing a microemulsion, the method including stirring the herbicidal composition at about 20° C. to about 30° C. Specifically, the composition contains a pyrimidinedione-based compound, an efficacy enhancer, a surfactant, and a solvent, and may further contain purified water as needed. Such a preparation method can produce a microemulsion formulation even without a separate warming process or strong stirring, so the microemulsion formulation can be prepared at low maintenance cost, and thus is also advantageous in process enlargement. Preferably, the stirring is carried out at a rate of about 300 rpm to about 500 rpm for about 10 minutes to about 30 minutes.

The suspension concentrate is a formulation in which a solid-phase pesticide active substance is dispersed in an aqueous solvent, such as water, and a non-aqueous solvent, such as mineral oil. The suspension concentrate is also referred to as a suspension preparation since pesticide active substance particles are dispersed when being diluted in water. Generally, the active ingredient, the surfactant, the thickener, the antifreezing agent, and the like can be mixed at an appropriate ratio, and for the increase of biological activity effects, an efficacy enhancer can be further added.

When diluted for the purpose of spraying, the suspension concentrate has few drift and less odor during cap opening and weighing, leading to a high handling advantage, and thus the suspension concentrate is regarded as one of the most preferred formulations by farmers.

The suspension concentrate according to the present disclosure is a water-base formulation in which a pyrimidinedione-based compound as an active ingredient is suspended in a form of fine particles in water. The suspension concentrate is an eco-friendly formulation due to the non-use of an organic solvent, and has less odor and causes less irritation. In addition, the suspension concentrate can be expected to show a synergistic efficacy effect through a mixture combination with glyphosate or glufosinate.

The suspension concentrate also retains thermodynamic stability by reducing the hydrolysis of the pyrimidinedione-based compound using an acidity regulator, thereby increasing storage stability. The suspension can show uniform and excellent efficacy at the time of chemical treatment through the uniform dispersion of the pyrimidinedione-based compound as an active ingredient.

Furthermore, the present disclosure provides a method for preparing the suspension concentrate. Specifically, the composition contains a pyrimidinedione-based compound, a glyphosate compound, a glufosinate compound, an efficacy enhancer, a surfactant, an acidity regulator, a thickener, a preservative, an antifreezing agent, and purified water. The corresponding preparation method can produce a product by separately carrying out a wet pulverization process performed including an active ingredient, a surfactant, an acidity regulator, a thickener, and purified water, a thickener preparation process performed including a thickener, a preservative, and purified water, and a process of stirring a glyphosate compound, a glufosinate compound, and an efficacy enhancer, and then mixing the resultant substances.

The water-dispersible granule formulation refers to a granular form of preparation wherein when water-dispersible granules are put in water and then stirred, granules are promptly disintegrated and then dispersed as solid-phase microparticles, and also refers to a granular preparation produced by dry pulverizing a solid-phase active ingredient, a surfactant, a filler, and the like, followed by kneading and assembling. The present formulation can contain an active substance with the highest content compared with any other formulation, and can be packaged in small quantities to minimize logistical costs. Therefore, a high-content water-dispersible granule formulation is a highly useful item for export. In addition, the water-dispersible granule formulation can optimize the biological effect enhancement through the mixed use with a tank mix adjuvant.

The water-dispersible granule formulation according to the present disclosure can be a formulation with a high content of a pyrimidinedione-based compound as a contact herbicide, has improved fast-acting property and sustainability on monocot weeds as well as broadleaf weeds through spreading ability and penetrating power enhanced by mixing combination with a tax mix adjuvant, and shows an effective control value, at a low dose, on even resistant weeds showing resistance to existing herbicides.

The present disclosure also provides a method for preparing the water-dispersible granules. Specifically, the composition contains a pyrimidinedione-based compound, a surfactant, an acidity regulator, and a filler. The corresponding preparation method can produce a product by separately and consecutively carrying out a milling process using a hammer mill or air mill, performed including an active ingredient, a surfactant, an acidity regulator, and a filler, an assembling process of kneading performed including purified water, followed by pelleting, and a drying process through a fluidized bed drier, and then selecting a final product.

In an embodiment of the present disclosure, the pyrimidinedione-based compound is tiafenacil. Tiafenacil is 3-[{2-[2-chloro-5-(3,6-dihydro-3-methyl-2,6-dioxo-4-trifluoromethyl-1(2H)-pyrimidinyl)-4-fluorophenylthio]-1-oxopropyl}amino]propanoic acid methyl ester, which is represented by chemical formula (I):

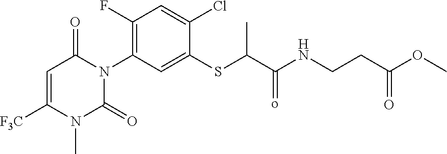

Tiafenacil is a pyrimidinedione-based compound, which is less toxic than the existing non-selective herbicide, paraquat, and causes no resistant weeds.

In an embodiment of the present disclosure, the efficacy enhancer is Alcohols, C₁₂₋₁₄ ethoxylated, or Alcohols C₉₋₁₁ ethoxylated propoxylated. The Alcohols, C₁₂₋₁₄ ethoxylated is a non-ionic surfactant in which ethylene oxide is added to a linear secondary alcohol having 12 to 14 carbon atoms, and is preferable as an enhancer, which enhances penetrating power through excellent wetting force, low surface tension, and high solubility. The Alcohols C₉₋₁₁ ethoxylated propoxylated is preferable since the compound has low irritation to eye while retaining an efficacy enhancing effect similar to that of the Alcohols, C₁₂₋₁₄ ethoxylated.

In an embodiment of the present disclosure, Alcohols, C₁₂₋₁₄ ethoxylated or Alcohols C₉₋₁₁ ethoxylated propoxylated as an efficacy enhancer for a tiafenacil solo-formulation may be added in an amount of 14-20 wt % on the basis of 100 wt % of the entire composition.

In an embodiment of the present disclosure, the Alcohols, C₁₂₋₁₄ ethoxylated or Alcohols C₉₋₁₁ ethoxylated propoxylated as an efficacy enhancer for a tiafenacil and glufosinate combination formulation may be added in an amount of 3-7 wt % on the basis of 100 wt % of the entire composition.

In an embodiment of the present disclosure, a mixture containing 1-dodecanaminium, N-(carboxymethyl)-N,N-dimethyl-, inner salt, 1-tetradecanaminium, N-(carboxymethyl)-N,N-dimethyl-, inner salt, glycerine, and water, as an efficacy enhancer for a tiafenacil and glyphosate combination formulation, may be added in an amount of 3-7 wt % on the basis of 100 wt % of the entire composition.

Therefore, the present disclosure provides a method for controlling weeds, the method including applying the herbicidal composition to weeds, seeds thereof, or a habitat thereof.

In an embodiment of the present disclosure, the weeds may be broadleaf weeds and monocot weeds, and the monocot weeds may be Gramineae family weeds and Cyperaceae family weeds. The broad-leaved weeds include Eclipta prostrata, Siegesbeckia pubescens, Centipeda minima, Artemisia princeps, Bidens frondosa, Taraxacum officinale, Galinsoga quadriradiata, Hemistepta lyrata, Youngia japonica, Siegesbeckia glabrescens, Ambrosia trifida, Ixeris dentata, Youngia sonchifolia, Lactuca indica, Breea segeta, Taraxacum platycarpum, Ambrosia artemisiifolia, Acalypha australis, Lindernia procumbens, Solanum nigrum, Quamoclit pennata, Calystegia japonica, Amaranthus lividus, Amaranthus retroflexus, Amaranthus hybridus, Abutilon theophrasti, Humulus japonicus, Portulaca oleracea, Commelina communis, Metaplexis japonica, Viola odorata, Trigonotis peduncularis, Plantago asiatica, Aeschynomene indica, Xanthium strumarium, Capsella burapastoris, Draba nemorosa, Galium spurium, Cerastium holoteoides, Rorippa islandica, Erigeron annuus, Conyza canadensis, Chelidonium majus, Lamium amplexicaule, Stellaria media, Chenopodium album, Vicia angustifolia, Sonchus asper, Veronica arvensis, Persicaria lapathifolia, Mollugo pentaphylla, Stellaria aquatic, Rumex japonicus, Trifolium repens, and Solidago Canadensis, but are not limited thereto. The Gramineae family weeds includes Digitaria ciliaris, Agropyron tsukushiense, Echinochloa crus-galli, Panicum dichotomiflorum, Eleusine indica, Setaria viridis, Setaria faberii, Poa sphondylodes, Poa pratensis, Sorghum bicolor, Alopecurus aequalis, Eriochloa gracilis, Imperata cylindrical, and Dallis grass, but are not limited thereto. The Cyperaceae family weeds include Cyperus difformis and Cyperus iria, but are not limited thereto. Other weeds include Equisetum arvense, which is notorious as a troublesome weed species, but are not limited thereto. That is, the herbicidal composition of the present disclosure can be applied to all of various species of weeds.

In an embodiment of the present disclosure, the herbicidal composition can be applied in a spray quantity of about 200 to about 1500 L/ha. Practically, the herbicidal composition is applied, depending on the spray nozzle and machine, in a spray quantity of about 1000 L/ha in Korea and about 200 L/ha in USA and Europe. The herbicidal composition attains high biological activity using even a low spray quantity, and thus can effectively control weeds.

Hereinafter, constituent elements and technical features of the present disclosure will be described in more detail with reference to the following examples. However, the following examples are provided merely to illustrate the present disclosure and not to restrict the scope of the present disclosure.

### EXAMPLE 1

### Surface Tension and Control Values of Samples Containing Tiafenacil Active Ingredient and Efficacy Enhancers

The present inventors conducted the following test by using tiafenacil, which is one of the representative pyrimidinedione-based compounds, as an active ingredient, and obtained results thereof. Tiafenacil, that is, 3-[{2-[2-chloro-5-(3,6-dihydro-3-methyl-2,6-dioxo-4-trifluoromethyl-1(2H)-pyrimidinyl)-4-fluorophenylthio]-1-oxopropyl}amino]propanoic acid methyl ester (Farm Hannong) is used as an active ingredient, and a total of 17 kinds of efficacy enhancers were prepared, including: three kinds of substances as organosilicon ethoxylate-based compounds; a polyoxyethylene polyoxypropylene block copolymer substance; two kinds of substances as polyoxyethylene alkyl ether-based compounds; Alcohols, C₁₂₋₁₄ ethoxylated; a polyoxylethylene polyoxypropylenes alkyl ether-based compound; Alcohols, C₉₋₁₁ ethoxylated propoxylated; four kinds of substances as fatty amine ethoxylated compounds; mono(2-propylheptyl)ether-based oxirane methyloxylan polymer; a quaternary ammonium salt compounds, a sodium alkyl sulfosuccinate compound; and a polyoxyethylene sorbitan alkyl ester compound.

For the selection of an efficacy enhancer composition capable of enhancing biological effects of the active ingredient tiafenacil, 0.2 mg of the active ingredient tiafenacil was dissolved in 33.3 ml of acetone, mixed with 66.6 ml of water, and then mixed with 50 ul of each efficacy enhancer. Then, weeds were subjected to herbicide treatment using each of these mixture liquids in a spray quantity of 1000 L/ha in a spray booth.

Pyrimidinedione-based herbicides are generally effective for broadleaf weeds, but have a tendency to be relatively ineffective in the Gramineae family weeds. Therefore, Digitaria ciliaris, which is not well controlled due to much hair on a leaf surface thereof, out of the Gramineae family, was used as a target weed species. The test was conducted by treatment of Digitaria ciliaris at the 4-leaf stage. The efficacy was evaluated as % control value by visual rating at 7 days after treatment. As for visual rating, the control value was set to 100% for complete control of weeds and 0% for no control of weeds.

For the measurement of the ability of each efficacy enhancer to reduce surface tension, the surface tension for each efficacy enhancer was measured by a surface tension meter, Wet-6000 (RHESCA), using a platinum pendulum with a length of 24 mm and a thickness of 1 mm under conditions of a temperature of 23.5° C. and humidity of 19%. The measured % control value and surface tension are shown in Table 1 below.

TABLE 1
Surface tension and control value of each efficacy enhancer
(Greenhouse test)

| | | | Evaluation | |
|---|---|---|---|---|
| | | | Surface | Control |
| | | Purity | tension | value |
| Sample | Efficacy enhancer | (%) | (Dyne/cm) | (%) |
| 1 | Control sample (Efficacy | — | 39.39 | 10 |
| | enhancer-free) | | | |
| 2 | Organic silicone ethoxylate- | 100 | 28.74 | 70 |
| | based compound #1 | | | |
| 3 | Organic silicone ethoxylate- | 100 | 27.48 | 77.5 |
| | based compound #2 | | | |
| 4 | Organic silicone ethoxylate- | 100 | 31.44 | 72.5 |
| | based compound #3 | | | |
| 5 | Polyoxyethylene | 100 | 36.55 | 50 |
| | polyoxypropylene block | | | |
| | copolymer | | | |
| 6 | Polyoxyethylene alkyl ether- | 100 | 30.12 | 70 |
| | based compound #1 | | | |
| 7 | Polyoxyethylene alkyl ether- | 100 | 29.22 | 65 |
| | based compound #2 | | | |
| 8 | Alcohols, C₁₂₋₁₄ ethoxylated | 100 | 29.57 | 90 |
| 9 | Polyoxyethylene | 100 | 32.34 | 55 |
| | polyoxypropylene | | | |
| | alkylether-based compound | | | |
| 10 | Alcohols C₉₋₁₁ ethoxylated | 100 | 30.47 | 80 |
| | propoxylated | | | |
| 11 | Fatty amine ethoxylate- | 100 | 26.67 | 77.5 |
| | based compound #1 | | | |
| 12 | Fatty amine ethoxylate- | 100 | 30.37 | 65 |
| | based compound #2 | | | |
| 13 | Fatty amine ethoxylate- | — | 32.96 | 75 |
| | based compound #3 | | | |
| 14 | Fatty amine ethoxylate- | 100 | 33.9 | 77.5 |
| | based compound #4 | | | |
| 15 | Oxirane, methyl-, polymer | 100 | 33.69 | 75 |
| | with oxirane, mono(2- | | | |
| | propylheptyl) ether | | | |
| 16 | Quaternary ammonium salt | 90 | 22.17 | 62.5 |
| 17 | Sodium alkyl | 90 | 20.51 | 62.5 |
| | sulfosuccinate-based | | | |
| | compound | | | |
| 18 | Polyoxyethylene sorbitan | 100 | 29.43 | 68.3 |
| | alkylester-based compound | | | |

As shown in Table 1, high percent (%) control values could be confirmed for most efficacy enhancers in the test. Especially, the highest percent (%) control value was obtained when the Alcohols, C₁₂₋₁₄ ethoxylated was used as an efficacy enhancer. That is, the Alcohols, C₁₂₋₁₄ ethoxylated showed a perfect spreading effect even though the spreading to Digitaria ciliaris is not well attained due to much hair on a leaf surface of Digitaria ciliaris, and improved penetration/transferability, which are weakness of contact pyrimidinedione-based herbicides, leading to excellent fast-acting property and an efficacy enhancing effect.

In a case of too low surface tension, chemicals flow down from side surfaces after chemical treatment, and in a case of too high surface tension, chemical liquids are formed into droplets, failing to attain uniform spreading, and therefore, it is necessary to retain an appropriate level of surface tension. It was confirmed, on the basis of the results of control value measurement, that the Alcohols, C₁₂₋₁₄ ethoxylated was most effective as an efficacy enhancer capable of enhancing biological activity of tiafenacil.

### EXAMPLE 2

### Control Value According to the Amount of Efficacy Enhancer Added

A test for determining the amount of an efficacy enhancer added was conducted by a similar method as in Example 1 while Alcohols, C₁₂₋₁₄ ethoxylated or Alcohols, C₉₋₁₁ ethoxylated propoxylated was used as an efficacy enhancer. Specifically, 0.2 mg of an active ingredient was dissolved in 33.3 ml of acetone, mixed with 66.6 ml of water, and then mixed with Alcohols, C₁₂₋₁₄ ethoxylated or Alcohols, C₉₋₁₁ ethoxylated propoxylated was used as an efficacy enhancer of 58.8 ul ( 1/1700 dilution), 50 ul ( 1/2000 dilution), 41.16 ul ( 1/2429 dilution) and 40 ul ( 1/2500 dilution). Then, weeds were subjected to chemical treatment using each of these mixture liquids in a spray quantity of 1000 L/ha in a spray booth in a greenhouse.

These correspond 1/1700 dilution (20 wt % addition), 1/2000 dilution (17 wt % addition), 1/2429 dilution (14 wt % addition), and 1/2500 dilution (13.6 wt % addition) in view of the efficacy enhancer compared with the spray quantity (1000 L/ha). Digitaria ciliaris at the 4-leaf stage was subjected to chemical treatment using each of corresponding samples in a spray quantity of 1000 L/ha. Like in a method that is commonly used for evaluating biological activity of an active substance, the efficacy was evaluated as a percent (%) control value by visual rating at 9 days after treatment, and the measured percent (%) control values are shown in Table 2 below. As for visual rating, the control value was set to 100% for complete control of weeds and 0% for no control of weeds.

TABLE 2
Control values for different addition amounts of efficacy
enhancers Alcohols, C₁₂₋₁₄ ethoxylated and Alcohols, C₉₋₁₁
ethoxylated propoxylated (Greenhouse test)

| | | | Control value |
|---|---|---|---|
| | | | (%) at 9 days |
| | | Amount of | after treatment |
| | Herbicidally | efficacy enhancer | Digitaria ciliaris |
| Sample | active compound | added (wt %) | (4LS, 8 cm) |
| 1 | Tiafenacil | Alcohols, C₁₂₋₁₄ | 97 |
| | 2 g ai/ha | ethoxylated, 20% | |
| 2 | Tiafenacil | Alcohols, C₁₂₋₁₄ | 92 |
| | 2 g ai/ha | ethoxylated, 17% | |
| 3 | Tiafenacil | Alcohols, C₁₂₋₁₄ | 90 |
| | 2 g ai/ha | ethoxylated, 14% | |
| 4 | Tiafenacil | Alcohols, C₁₂₋₁₄ | 79 |
| | 2 g ai/ha | ethoxylated, 13.6% | |
| 5 | Tiafenacil | Alcohols C₉₋₁₁ | 95 |
| | 2 g ai/ha | ethoxylated | |
| | | propoxylated, 20% | |
| 6 | Tiafenacil | Alcohols C₉₋₁₁ | 91 |
| | 2 g ai/ha | ethoxylated | |
| | | propoxylated, 17% | |
| 7 | Tiafenacil | Alcohols C₉₋₁₁ | 88 |
| | 2 g ai/ha | ethoxylated | |
| | | propoxylated, 14% | |
| 8 | Tiafenacil | Alcohols C₉₋₁₁ | 72 |
| | 2 g ai/ha | ethoxylated | |
| | | propoxylated, 13.6% | |

As shown in Table 2, the efficacy enhancers Alcohols, C₁₂₋₁₄ ethoxylated and Alcohols, C₉₋₁₁ ethoxylated propoxylated showed an increased effect as the amount of the active ingredient increased. The control value was remarkably increased in the 1/1700 dilution (20 wt % addition) on the basis of the spray quantity compared with 1/2500 dilution (13.6 wt % addition). It can also be seen that the control value was greatly increased in the 1/2429 dilution (14 wt % insertion) compared with the 1/2500 dilution (13.6 wt % insertion) although the difference in weight percent is not great. A more increased amount of the efficacy enhancer is expected to lead to an increase in effect, but as the amount of the efficacy enhancer added is increased, the irritation to eyes may become severe and material costs may increase. Therefore, the appropriate proportion of the efficacy enhancer added in a product is 14-20 wt %, leading to an excellent control effect.

### EXAMPLE 3

### Control Values of Samples Containing Tiafenacil Solo-Formulation Microemulsion and Efficacy Enhancers

The present inventors also investigated the effects of Alcohols, C₉₋₁₁ ethoxylated propoxylated, which shows a similar efficacy enhancing effect to the Alcohols, C₁₂₋₁₄ ethoxylated, and less irritation to eyes.

Specifically, Microemulsion formulation (ME) was prepared by mixing 5 wt % of the active ingredient tiafenacil and the efficacy enhancer Alcohols, C₉₋₁₁ ethoxylated propoxylated or Alcohols, C₁₂₋₁₄ ethoxylated (14 wt % and 17 wt % addition). Then, weeds were subjected to chemical treatment using each of these mixture liquids in a spray quantity of 1000 L/ha in a spray booth. The active ingredient was 10 g ai/ha, 20 g ai/ha, and 40 g ai/ha for the treatment.

The target weeds Echinochloa crus-galli and Amaranthus mangostanus were treated with 12 samples. The efficacy was evaluated as the percent (%) control value by visual rating at 4, 11 and 20 days after treatment. As for visual rating, the control value was set to 100% for complete control of weeds and 0% for no control of weeds.

TABLE 3
Control value of tiafenacil solo-formulation microemulsion
according to the amount of efficacy enhancers
Alcohols, C₁₂₋₁₄ ethoxylated and Alcohols, C₉₋₁₁
ethoxylated propoxylated (greenhouse experiment)

| | | | | Control value(%) at 4, 11 | | | | | |
|---|---|---|---|---|---|---|---|---|---|
| | | | | and 20 days after treatment | | | | | |
| | | | Amount | Echinochloa | | | Amaranthus | | |
| | | | of | crus-galli | | | mangostanus | | |
| | Herbicidally | | active | (30~35 cm) | | | (25~30 cm) | | |
| Sam- | active | Efficacy | ingredient | 4 | 11 | 20 | 4 | 11 | 20 |
| ple | compound | enhancer | (gai/ha) | DAT | DAT | DAT | DAT | DAT | DAT |
| 1 | Tiafenacil | Alcohols, | 10 | 10 | 13 | 15 | 60 | 70 | 78 |
| | 5% | C₁₂₋₁₄ | | | | | | | |
| | ME | ethoxylated, | | | | | | | |
| | | 17% | | | | | | | |
| 2 | Tiafenacil | Alcohols, | 20 | 25 | 25 | 25 | 80 | 90 | 97 |
| | 5% | C₁₂₋₁₄ | | | | | | | |
| | ME | ethoxylated, | | | | | | | |
| | | 17% | | | | | | | |
| 3 | Tiafenacil | Alcohols, | 40 | 55 | 60 | 60 | 88 | 92 | 94 |
| | 5% | C₁₂₋₁₄ | | | | | | | |
| | ME | ethoxylated, | | | | | | | |
| | | 17% | | | | | | | |
| 4 | Tiafenacil | Alcohols, | 10 | 10 | 30 | 35 | 50 | 60 | 75 |
| | 5% | C₁₂₋₁₄ | | | | | | | |
| | ME | ethoxylated, | | | | | | | |
| | | 14% | | | | | | | |
| 5 | Tiafenacil | Alcohols, | 20 | 35 | 33 | 25 | 65 | 75 | 75 |
| | 5% | C₁₂₋₁₄ | | | | | | | |
| | ME | ethoxylated, | | | | | | | |
| | | 14% | | | | | | | |
| 6 | Tiafenacil | Alcohols, | 40 | 60 | 60 | 55 | 90 | 99 | 99 |
| | 5% | C₁₂₋₁₄ | | | | | | | |
| | ME | ethoxylated, | | | | | | | |
| | | 14% | | | | | | | |
| 7 | Tiafenacil | Alcohols, | 10 | 10 | 20 | 25 | 50 | 70 | 75 |
| | 5% | C₉₋₁₁ | | | | | | | |
| | ME | ethoxylated | | | | | | | |
| | | propoxylated, | | | | | | | |
| | | 17% | | | | | | | |
| 8 | Tiafenacil | Alcohols | 20 | 25 | 30 | 30 | 83 | 90 | 91 |
| | 5% | C₉₋₁₁ | | | | | | | |
| | ME | ethoxylated | | | | | | | |
| | | propoxylated, | | | | | | | |
| | | 17% | | | | | | | |
| 9 | Tiafenacil | Alcohols | 40 | 40 | 70 | 55 | 85 | 94 | 95 |
| | 5% | C₉₋₁₁ | | | | | | | |
| | ME | ethoxylated | | | | | | | |
| | | propoxylated, | | | | | | | |
| | | 17% | | | | | | | |
| 10 | Tiafenacil | Alcohols, | 10 | 10 | 13 | 15 | 45 | 75 | 73 |
| | 5% | C₉₋₁₁ | | | | | | | |
| | ME | ethoxylated | | | | | | | |
| | | propoxylated, | | | | | | | |
| | | 14% | | | | | | | |
| 11 | Tiafenacil | Alcohols | 20 | 25 | 25 | 23 | 78 | 80 | 83 |
| | 5% | C₉₋₁₁ | | | | | | | |
| | ME | ethoxylated | | | | | | | |
| | | propoxylated, | | | | | | | |
| | | 14% | | | | | | | |
| 12 | Tiafenacil | Alcohols | 40 | 45 | 73 | 58 | 83 | 85 | 85 |
| | 5% | C₉₋₁₁ | | | | | | | |
| | ME | ethoxylated | | | | | | | |
| | | propoxylated, | | | | | | | |
| | | 14% | | | | | | | |

As shown in Table 3, the Alcohols, C₉₋₁₁ ethoxylated propoxylated showed an efficacy enhancing effect similar to that of the Alcohols, C₁₂₋₁₄ ethoxylated, which has been verified as the most effective efficacy enhancer through Example 1.

That is, the Alcohols, C₉₋₁₁ ethoxylated propoxylated was confirmed to be an efficacy enhancer capable of enhancing the biological activity of tiafenacil.

The following cultivated target weeds were subjected to treatment using samples containing 17% of the efficacy enhancer Alcohols, C₉₋₁₁ ethoxylated propoxylated in a spray quantity of 1000 L/ha in greenhouse conditions while the active ingredient was 4-32 g ai/ha, and then biological activity of the samples were evaluated. The measured biological activity of each sample was obtained by visual rating, and the measurement results are shown in Tables 4 to 6 below. As for visual rating, the control value was set to 100% for complete control weeds and 0% for no control of weeds.

TABLE 4
Biological activity of tiafenacil solo-formulation microemulsion on
various weed species in greenhouse in the application of efficacy
enhancer Alcohols, C₉₋₁₁ ethoylated propoylated (Greenhouse test)

| | | A- | Control value(%) at 15 days after treatment | | | | |
|---|---|---|---|---|---|---|---|
| | | mount | | | Caly- | Amaran- | |
| Herbi- | | of | Sola- | Quam- | stegia | thus | |
| cidally | | active | num | oclit | japon- | retro- | Abutilon |
| active | | ingre- | nigrum | pennata | ica | flexus | theophrasti |
| com- | Efficacy | dient | 3 LS, | 3~5 LS, | 5~7 LS, | 2~3 LS, | 3~4 LS, |
| pound | enhancer | (gai/ha) | 5~7 cm | 18~35 cm | 5~10 cm | 5~8 cm | 8~10 cm |
| Tiafenacil | Alcohols | 4 | 100 | 100 | 100 | 100 | 100 |
| 5% | C₉₋₁₁ | 8 | 100 | 100 | 100 | 100 | 100 |
| ME | ethoxylated | 16 | 100 | 100 | 100 | 100 | 100 |
| | propoxylated, | 32 | 100 | 100 | 100 | 100 | 100 |
| | 17% | | | | | | |

TABLE 5
Biological activity of tiafenacil solo-formulation microemulsion on
various weed species in greenhouse in the application of efficacy
enhancer Alcohols, C₉₋₁₁ ethoylated propoylated (Greenhouse test)

| | | | Control value(%) at 15 days after treatment | | | |
|---|---|---|---|---|---|---|
| | | Amount | | | | |
| Herbi- | | of | Aeschy- | Xan- | Cype- | |
| cidally | | active | nomene | thium | rus | Panicum |
| active | | ingre- | indica | strumarium | iris | dichotomiflorum |
| com- | Efficacy | dient | 4 LS, | 3~4 LS, | 2 LS, | 2~3 LS, |
| pound | enhancer | (g ai/ha) | 12~17 cm | 5~9 cm | 5~9 cm | 4~7 cm |
| Alcohols | C₉₋₁₁ | 4 | 100 | 100 | 93 | 55 |
| Tiafenacil | ethoxylated | 8 | 100 | 100 | 100 | 73 |
| 5% ME | propoxylated, | 16 | 100 | 100 | 100 | 90 |
| | 17% | 32 | 100 | 100 | 100 | 98 |

TABLE 6
Biological activity of tiafenacil solo-formulation microemulsion on
various weed species in greenhouse in the application of efficacy
enhancer Alcohols, C₉₋₁₁ ethoylated propoylated (Greenhouse test)

| | | | Control value(%) at 15 days after | | | |
|---|---|---|---|---|---|---|
| | | Amount | treatment | | | |
| Herbi- | | of | Echinochloa | Digitaria | Setaria | Sorghum |
| cidally | | active | crus-galli | ciliaris | viridis | bicolor |
| active | Efficacy | ingredient | 3~3.5 LS, | 3~3.5 LS, | 2~3 LS, | 4~4.5 LS, |
| compound | enhancer | (g ai/ha) | 18~25 cm | 20~23 cm | 14~18 cm | 40 cm |
| Tiafenacil | Alcohols C₉₋₁₁ | 4 | 75 | 80 | 100 | 95 |
| 5% ME | ethoxylated | 8 | 100 | 93 | 100 | 98 |
| | propoxylated, | 16 | 100 | 100 | 100 | 100 |
| | 17% | 32 | 100 | 100 | 100 | 100 |

As shown in Tables 4 to 6, the herbicidal compositions containing the microemulsion formulations prepared in the present disclosure had enhanced spreading ability and penetrating power, and thus showed an excellent biological effect on the Gramineae family weeds as well as broadleaf weeds and effective control can be attained even at a low dose. The prepared samples are important in that the samples basically showed remarkable control values on broadleaf weeds, especially, Solanum nigrum, Quamoclit pennata, Calystegia japonica, Amaranthus retroflexus, Abutilon theophrasti, Aeschynomene indica, Xanthium strumarium, and Cyperus iris, and also showed excellent effects on the Gramineae family weeds, such as Fall panicum, Echinochloa crus-galli, Digitaria ciliaris, Setaria viridis, Setaria faberii, Sorghum bicolor, and the like.

The amount of the active ingredient in the samples containing 17% of the efficacy enhancer Alcohols, C₉₋₁₁ ethoxylated propoxylated was fixed to 150 g ai/ha and the samples were applied in a spray quantity of 1000 L/ha to the target weeds on Table 5 below in field conditions. The biological activity of these samples was evaluated in comparison with those of the conventional herbicides paraquat, glufosinate, and glyphosate. The measured biological activity of each sample was obtained by evaluation through visual rating, and the measurement results are shown in Tables 7 to 14 below. As for visual rating, the control value was set to 100% for complete control of weeds and 0% for no control of weeds.

TABLE 7
Biological activity of tiafenacil solo-formulation microemulsion in
application of efficacy enhancer Alcohols, C₉₋₁₁ ethoxylated
propoxylated in field conditions (Field test)

| | | Control value (6) when maximal effect was shown | | | | |
|---|---|---|---|---|---|---|
| | Amount of | | | | | |
| | active | | | | | |
| | ingre- | Capsella | Drabs | Trigonotis | Galium | Cerastium |
| | dient | burapastoris | nemorosa | peduncularis | spurium | holoteoides |
| Sample | (g ai/ha) | 47 cm | 36 cm | 15 cm | 35 cm | 24 cm |
| Tiafenacil | 150 | 100 | 100 | 100 | 100 | 95 |
| 5% ME | | | | | | |
| Paraquat | 1,155 | 100 | 100 | — | 100 | 100 |
| dichloride | | | | | | |
| 23.1% SL | | | | | | |
| Glufosinate- | 900 | 90 | 100 | 100 | 100 | 100 |
| Am 18% SL | | | | | | |
| Glyphosate- | 2,050 | 100 | 100 | 100 | 100 | 100 |
| IPA 41% SL | | | | | | |

TABLE 8
Biological activity of tiafenacil solo-formulation microemulsion in application of efficacy
enhancer Alcohols, C₉₋₁₁ ethoylated propoxylated in field conditions (Field test)

| | | Control value(%) when maximal effect was shown | | | | |
|---|---|---|---|---|---|---|
| | Amount | | | | | |
| | of | | | | | |
| | active | | Erig- | | | |
| | ingre- | Rorippa | eron | Conyza | Chelidonium | Lamium |
| | dient | islandica | annus | canadensis | majus | amplexicaule |
| Sample | (g ai/ha) | 40 cm | 40 cm | 40 cm | 65 cm | 30 cm |
| Tiafenacil | 150 | 99 | 95 | 95 | 100 | 100 |
| 5% ME | | | | | | |
| Paraquat | 1,155 | 99 | 100 | — | 100 | 100 |
| dichloride | | | | | | |
| 23.1% SL | | | | | | |
| Glufosinate- | 900 | 99 | 100 | 100 | 100 | 100 |
| Ara 18% SL | | | | | | |
| Glyphosate- | 2,050 | 100 | 100 | — | 100 | 100 |
| IPA 41% SL | | | | | | |

TABLE 9
Biological activity of tiafenacil solo-formulation microemulsion in
application of efficacy enhancer Alcohols, C₉₋₁₁ ethoylated
propoxylated in field conditions (Field test)

| | | Control value(%) when | | | | |
|---|---|---|---|---|---|---|
| | Amount | maximal effect was shown | | | | |
| | of | | | | | |
| | active | Stel- | | Cheno- | Por- | |
| | ingre- | laria | Abutilon | podium | tulaca | Acalypha |
| | dient | media | theophrasti | album | oleracea | australis |
| Sample | (g ai/ha) | 24 cm | 100 cm | 75 cm | 50 cm | 45 cm |
| Tiafenacil | 150 | 97 | 100 | 98 | 98 | 100 |
| 5% ME | | | | | | |
| Paraquat | 1,155 | 100 | 95 | 100 | 94 | 100 |
| dichloride | | | | | | |
| 23.1% SL | | | | | | |
| Glufosinate- | 900 | 100 | 85 | 99 | 92 | 78 |
| Am 18% SL | | | | | | |
| Glyphosate- | 2,050 | 100 | 68 | 100 | 98 | 94 |
| IPA 41% SL | | | | | | |

TABLE 10
Biological activity of tiafenacil solo-formulation microemulsion in application of
efficacy enhancer Alcohols, C₉₋₁₁ ethoxylated propoxylated in field conditions (Field test)

| | Amount of | Control value(%) when maximal effect was shown | | | | |
|---|---|---|---|---|---|---|
| | active | Eclipta | Commelina | Vicia | Sonchus | Veronica |
| | ingredient | prostrata | communis | angustifolia | asper | arvensis |
| Sample | (g ai/ha) | 23 cm | 45 cm | 31 cm | 43 cm | 25 cm |
| Tiafenacil | 150 | 100 | 97 | 100 | 100 | 100 |
| 5% ME | | | | | | |
| Paraquat | 1,155 | 100 | 97 | 100 | 100 | 100 |
| dichloride | | | | | | |
| 23.1% SL | | | | | | |
| Glufosinate- | 900 | 100 | 88 | 100 | 100 | 100 |
| Am 18% SL | | | | | | |
| Glyphosate- | 2,050 | 100 | 83 | 100 | 100 | 100 |
| TPA 41% | | | | | | |
| SL | | | | | | |

TABLE 11
Biological activity of tiafenacil solo-formulation microemulsion in
application of efficacy enhancer Alcohols, C₉₋₁₁ ethoylated
propoxylated in field conditions (Field test)

| | Amount | Control value(%) when maximal effect was shown | | | | |
|---|---|---|---|---|---|---|
| | of | | | | | |
| | active | Ama- | Persi- | | | |
| | ingre- | ranthus | caria | Mollugo | Galinsoga | Centipeda |
| | dient | hybridus | lapathifolia | pentaphylla | quadriradiata | minima |
| Sample | (g ai/ha) | 43 cm | 53 cm | 13 cm | 35 cm | 7 cm |
| Tiafenacil | 150 | 96 | 100 | 98 | 100 | 100 |
| 5% ME | | | | | | |
| Paraquat | 1,155 | 100 | 100 | 100 | 100 | 99 |
| dichloride | | | | | | |
| 23.1% SL | | | | | | |
| Glufosinate- | 900 | 98 | 100 | 100 | 100 | 100 |
| Am 18% SL | | | | | | |
| Glyphosate- | 2,050 | 100 | 100 | 100 | 100 | — |
| TPA 41% SL | | | | | | |

TABLE 12
Biological activity of tiafenacil solo-formulation microemulsion in
application of efficacy enhancer Alcohols, C₉₋₁₁ ethoxylated
propoxylated in field conditions (Field test)

| | | Control value(%) when maximal effect was shown | | | | |
|---|---|---|---|---|---|---|
| | Amount | | | | Tarax- | |
| | of active | Siegesbeckia | Artemisia | Stellaria | acum | Calystegia |
| | ingredient | glabrescens | princeps | aquatic | platycarpum | japonica |
| Sample | (g ai/ha) | 38 cm | 50 cm | 41 mm | 40 mm | 25 cm |
| Tiafenacil | 150 | 100 | 95 | 95 | 97 | 100 |
| 5% ME | | | | | | |
| Paraquat | 1,155 | 100 | 95 | 100 | 97 | 99 |
| dichloride | | | | | | |
| 23.1% SL | | | | | | |
| Glufosinate- | 900 | 100 | 95 | 90 | 92 | 98 |
| Am 18% SL | | | | | | |
| Glyphosate- | 2,050 | — | 99 | 100 | 100 | 80 |
| TPA 41% SL | | | | | | |

TABLE 13
Biological activity of tiafenacil solo-formulation microemulsion in
application of efficacy enhancer Alcohols, C₉₋₁₁ ethoxylated
propoxylated in field conditions (Field test)

| | Amount | Control value(%) when maximal effect was shown | | | | |
|---|---|---|---|---|---|---|
| | of active | | | | | |
| | ingre- | Rumex | Trifolium | Solidago | Alopecurus | Echinochloa |
| | dient | japonicus | repens | Canadensis | aequalis | crus-galli |
| Sample | (g ai/ha) | 38 cm | 25 cm | 50 cm | 42 cm | 65 cm |
| Tiafenacil | 150 | 99 | 98 | 99 | 95 | 95 |
| 5% ME | | | | | | |
| Paraquat | 1,155 | 96 | 91 | 99 | 98 | 92 |
| dichloride | | | | | | |
| 23.1% SL | | | | | | |
| Glufosinate- | 900 | 99 | 97 | 94 | 98 | 98 |
| Am 18% SL | | | | | | |
| Glyphosate- | 2,050 | 100 | 98 | 90 | 99 | 99 |
| IPA 41% SL | | | | | | |

TABLE 14
Biological activity of tiafenacil solo-formulation microemulsion in
application of efficacy enhancer Alcohols, C₉₋₁₁ ethoxylated
propoxylated in field conditions (Field test)

| | Amount | Control value(%) when maximal effect was shown | | | | | |
|---|---|---|---|---|---|---|---|
| | of active | Digi- | | Equi- | | Imperata | |
| | ingre- | taria | Eriochloa | setum | Agropyron | cylin- | Dalli |
| | dient | ciliaris | gracils | arvense | tsukushiense | drical | grass |
| Sample | (g ai/ha) | 51 cm | 30 cm | 40 mm | 32 cm | 50 cm | 30 cm |
| Tiafenacil | 150 | 95 | 96 | 95 | 94 | 92 | 96 |
| 5% ME | | | | | | | |
| Paraquat | 1,155 | 94 | 94 | 94 | 95 | 96 | 95 |
| dichloride | | | | | | | |
| 23.1% SL | | | | | | | |
| Glufosinate- | 900 | 97 | 99 | 95 | 96 | 96 | 99 |
| Am 18% SL | | | | | | | |
| Glyphosate- | 2,050 | 100 | — | — | 100 | 89 | — |
| IPA 41% SL | | | | | | | |

As shown in Tables 7 to 14, the herbicidal compositions containing the microemulsion formulation prepared in the present disclosure showed broadly excellent control values as herbicides for annual and perennial weeds using even a very small amount of active ingredient compared with conventional herbicides, so that the herbicidal compositions could stand comparison with the conventional herbicides.

### EXAMPLE 4

### Control Value of Samples Containing Tiafenacil Solo-Formulation Suspension Concentrate and Efficacy Enhancer

The effects of tiafenacil solo-formulation suspension concentrate (SC) containing an efficacy enhancer was investigated in comparison with those of the tiafenacil solo-formulation microemulsions (ME).

A non-crop land with large and overgrown weeds was treated with mixture liquids of respective preparation products in a spray quantity of 1500 L/ha using a backpack type sprayer while the amount of an active ingredient was set to 250 g ai/ha.

In a field for testing, Digitaria ciliaris Echinochloa crus-galli, and Oenothera odorata, were enough to test. The efficacy was evaluated as the percent (%) control value by visual rating at 5, 19 and 35 days after treatment. For visual rating, the control value was set to 100% for complete control of weeds and 0% for no control of weeds.

TABLE 15
Biological activity of tiafenacil solo-formulation suspension
concentrate in application of efficacy enhancer Alcohols, C₉₋₁₁
ethoxylated propoxylated (Field test)

| | | Control value (%) | | | | | | | | |
|---|---|---|---|---|---|---|---|---|---|---|
| | Amount | | | | | | | | | |
| | of | | | | Echinochloa | | | Oenothera | | |
| | active | Digitaria | | | crus- | | | odorata | | |
| | ingredient | ciliaris (40cm) | | | galli (45cm) | | | (40cm) | | |
| | (g ai/ | 5 | 19 | 35 | 5 | 19 | 35 | 5 | 19 | 35 |
| Sample | ha)) | DAT | DAT | DAT | DAT | DAT | DAT | DAT | DAT | DAT |
| Tiafenacil | 250 | 59 | 85 | 65 | 50 | 80 | 60 | 100 | 98 | 100 |
| 5% SC | | | | | | | | | | |
| Tiafenacil | 250 | 60 | 85 | 60 | 75 | 80 | 60 | 100 | 100 | 100 |
| 5% ME | | | | | | | | | | |

DAT : Days after treatment

As shown in Table 15, there were slight differences in control values according to the kind of weeds and investigation date, and the effects of the two products were similar to each other.

### EXAMPLE 5

### Control Value of Samples Containing Tiafenacil Solo-Formulation High-Content Water-Dispersible Granule and Efficacy Enhancer

In order to evaluate effects of tiafenacil solo-formulation high-content water-dispersible granule (WG), the water-dispersible granule were tank-mixed with an applicable efficacy enhancer, and compared with a tiafenacil solo-formulation microemulsion.

The weeds were treated with each of mixture liquids of respective preparation products in a spray quantity of 1000 L/ha in a spray booth. The amount of the active ingredient was 25 and 100 g ai/ha, and the dose thereof was treated such that the effect comparison between products can be conducted according to the weed size.

The efficacy was evaluated as the percent (%) control value by visual rating at 4, 10 days or 2, 6 and 14 days after treatment. As for visual rating, the control value was set to 100% for complete control of weeds and 0% for no control of weeds.

TABLE 16
Evaluation test of biological activity according to efficacy
enhancer of tiafenacil solo-formulation high-content water
dispersible granule (Greenhouse test)

| | | Control value(%), at 4 and 10 days | | | |
|---|---|---|---|---|---|
| | | after treatment | | | |
| | Amount | Echinochloa | | | |
| | of active | crus-galli | | Digitaria ciliaris | |
| | ingredient | (27~34 cm) | | (28~33 cm) | |
| Sample | (g ai/ha) | 4DAT | 10DAT | 4DAT | 10DAT |
| Tiafenacil | 25 | 91 | 91 | 93 | 89 |
| 5% ME | | | | | |
| Tiafenacil | 25 | 91 | 97 | 98 | 97 |
| 70% WG + | | | | | |
| Hasten* 0.5% | | | | | |
| Tiafenacil | 25 | 94 | 98 | 97 | 99 |
| 70% WG + | | | | | |
| MSO** 0.5% | | | | | |
| Tiafenacil | 25 | 96 | 97 | 97 | 96 |
| 70% WG + | | | | | |
| COC*** 0.5% | | | | | |
| Tiafenacil | 25 | 95 | 100 | 97 | 98 |
| 70% WG + | | | | | |
| Hasten* 1% | | | | | |
| Tiafenacil | 25 | 94 | 98 | 99 | 100 |
| 70% WG + | | | | | |
| MSO** 1% | | | | | |
| Tiafenacil | 25 | 94 | 98 | 99 | 99 |
| 70% WG + | | | | | |
| COC*** 1% | | | | | |

*Spray adjuvant product (Victorian Chemical Co. Pty. Ltd.)
**Methylated Soybean Oil
***Crop Oil Concentrate

TABLE 17
Biological activity comparison evaluation between
tiafenacil solo-formulation high-content water dispersible
granule and solo-formulation microemulsion (Field test)

| | | Control value(%), at 2, 4 and | | | | | |
|---|---|---|---|---|---|---|---|
| | Amount | 14 days after treatment | | | | | |
| | of | Echinochloa | | | | | |
| | active | crus- | | | | | |
| | ingre- | galli | | | Digitaria ciliaris | | |
| | dient | (45~60 cm) | | | (25~35 cm) | | |
| | (g ai/ | 2 | 6 | 14 | 2 | 6 | 14 |
| Sample | ha) | DAT | DAT | DAT | DAT | DAT | DAT |
| Tiafenacil | 100 | 87 | 95 | 80 | 87 | 100 | 80 |
| 70% WG + | | | | | | | |
| MSO** 1% | | | | | | | |
| Tiafenacil 5% | 100 | 91 | 98 | 87 | 91 | 100 | 83 |
| ME | | | | | | | |

*Spray adjuvant product (Victorian Chemical Co. Pty. Ltd.)
**Methylated Soybean Oil
***Crop Oil Concentrate

The tiafenacil solo-formulation high-content water-dispersible granule (WG), together with Tank-mix spreader, such as methylated soybean oil (MSO) frequently used in the current markets, showed similar effects compared with microemulsion, with no difference according to the kind of weeds and investigation date. There was no difference in effect among three kinds of efficacy enhancers (Hasten, MSO, COC) used in the test.

### EXAMPLE 6

### Control Values of Samples Containing Tiafenacil-Glyphosate Combination Formulation and Efficacy Enhancers

The control values of samples containing tiafenacil-glyphosate combination formulation as an herbicidally active compound and efficacy enhancers were measured. As for efficacy enhancers, 10 wt % of an alkyl polyglucoside was used as an efficacy enhancer of glyphosate, and polyoxyethylene lauryl ether, polyoxyethylene tridecyl ether, Alcohols, C₁₂₋₁₄ ethoxylated, a mixture of 1-dodecanaminium, N-(carboxymethyl)-N,N-dimethyl-, inner salt, 1-tetradecanaminium, N-(carboxymethyl)-N,N-dimethyl-, inner salt, glycerin, and water, or polyoxyethylene sorbitan monolaurate was used as an efficacy enhancer of tiafenacil.

The mixture of 1-dodecanaminium, N-(carboxymethyl)-N,N-dimethyl-, inner salt, 1-tetradecanaminium, N-(carboxymethyl)-N,N-dimethyl-, inner salt, glycerin, and water, which was most effective, was added in an amount of 7 wt %, 5 wt %, 3 wt %, and 2.6 wt %, and the control value according to the addition amount was measured.

The target weeds Digitaria ciliaris and Echinochloa crus-galli with two tillers were treated with the corresponding samples in a spray quantity of 1000 L/ha. As in the method commonly used for evaluating biological activity of an active substance, the efficacy was evaluated as a percent (%) control value by visual rating at 33 days after treatment. As for visual rating, the control value was set to 100% for complete control of weeds and 0% for no control of weeds.

The measured percent (%) control values are shown in Table 18 below.

TABLE 18
Control values of tiafenacil and glyphosate combination formulation according to amount of
efficacy enhancer added (Greenhous test)

| | | | | Control value(%) at | |
|---|---|---|---|---|---|
| | | | | 33 day after treatment | |
| | | | | | Digitaria |
| | Herbicidally | | Amount | Echinochloa | ciliaris |
| | active | | of active | crus-galli | (2TL, |
| Sample | compound | Efficacy enhancer (wt %) | ingredient | (2TL, 54 cm) | 50 cm) |
| 1 | Glyphosate + | Alkylpolygluco- | 600 + 12.5 | 5 | 83 |
| | Tiafenacil | side(10%) + | | | |
| | | Polyoxyethylene lauryl | | | |
| | | ether (5%) | | | |
| 2 | +Tiafenacil | +Polyoxyethylene | 1200 + 25 | 90 | 94 |
| | | lauryl ether (5%) | | | |
| 3 | Glyphosate + | Alkylpolygluco- | 600 + 12.5 | 5 | 85 |
| | Tiafenacil | side(10%) + | | | |
| | | Polyoxyethylene tridecyl | | | |
| | | ether (5%) | | | |
| 4 | +Tiafenacil | +Polyoxyethylene | 1200 + 25 | 82 | 95 |
| | | tridecyl ether (5%) | | | |
| 5 | Glyphosate + | Alkylpolygluco- | 600 + 12.5 | 5 | 85 |
| | Tiafenacil | side(10%) + Alcohols, | | | |
| | | C₁₂₋₁₄ ethoxylated (5%) | | | |
| 6 | +Tiafenacil | +Alcohols, C₁₂₋₁₄ | 1200 + 25 | 91 | 97 |
| | | ethoxylated (5%) | | | |
| 7 | Glyphosate + | Alkylpolygluco- | 600 + 12.5 | 19 | 90 |
| | Tiafenacil | side(10%) + Mixture of | | | |
| | | 1-Dodecanaminium, N- | | | |
| | | (carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(7%) | | | |
| 8 | +Tiafenacil | +Mixture of 1- | 1200 + 25 | 97 | 99 |
| | | Dodecanaminium, N- | | | |
| | | (carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(7%) | | | |
| 9 | Glyphosate + | Alkylpolygluco- | 600 + 12.5 | 17 | 87 |
| | Tiafenacil | side(10%) + Mixture of | | | |
| | | 1-Dodecanaminium, N- | | | |
| | | (carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(5%) | | | |
| 10 | +Tiafenacil | +Mixture of 1- | 1200 + 25 | 96 | 98 |
| | | Dodecanaminium, | | | |
| | | N-(carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(5%) | | | |
| 11 | Glyphosate + | Alkylpolygluco- | 600 + 12.5 | 17 | 83 |
| | Tiafenacil | side(10%) + Mixture of | | | |
| | | 1-Dodecanaminium, N- | | | |
| | | (carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(3%) | | | |
| 12 | +Tiafenacil | +Mixture of 1- | 1200 + 25 | 96 | 95 |
| | | Dodecanaminium, | | | |
| | | N-(carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(3%) | | | |
| 13 | Glyphosate + | Alkylpolygluco- | 600 + 12.5 | 5 | 77 |
| | Tiafenacil | side(10%) + Mixture of 1- | | | |
| | | Dodecanaminium, | | | |
| | | N-(carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(2.6%) | | | |
| 14 | +Tiafenacil | +Mixture of 1- | 1200 + 25 | 76 | 89 |
| | | Dodecanaminium, | | | |
| | | N-(carboxymethyl)-N,N- | | | |
| | | dimethyl-, inner salt, | | | |
| | | 1-Tetradecanaminium, | | | |
| | | N-(carboxymethyl)-N,N- | | | |
| | | dimethyl-, inner salt, | | | |
| | | Glycerine(2.6%) | | | |
| 15 | Glyphosate + | Alkylpolygluco- | 600 + 12.5 | 5 | 60 |
| | Tiafenacil | side(10%) + | | | |
| | | Polyoxyethylene sorbitan | | | |
| | | monolaurate (5%) | | | |
| 16 | +Tiafenacil | +Polyoxyethylene sorbitan | 1200 + 25 | 63 | 74 |
| | | monolaurate (5%) | | | |

As shown in Table 18, when polyoxyethylene lauryl ether or polyoxyethylene tridecyl ether is added (Sample Nos. 1 to 4), the control effect was not bad, but when polyoxyethylene lauryl ether or polyoxyethylene tridecyl ether is used as a built-in to the suspension concentrate (SC) of a herbicidally active compound, uniform mixing did not occur, resulting in poor physical stability. It can be seen that the control effect was increased more significantly when Alcohols, C12-14 ethoxylated or a mixture of 1-dodecanaminium, N-(carboxymethyl)-N,N-dimethyl-, inner salt, 1-tetradecanaminium, N-(carboxymethyl)-N,N-dimethyl-, inner salt, glycerin, and water, as an efficacy enhancer, is added to the tiafenacil and glyphosate mixed preparation (Sample Nos. 5 to 9) rather than when polyoxyethylene sorbitan monolaurate as an efficacy enhancer is added (Sample No. 15). The control effect also increased as the amount of an active ingredient in the mixture containing 1-dodecanaminium, N-(carboxymethyl)-N,N-dimethyl-, inner salt, 1-tetradecanaminium, N-(carboxymethyl)-N,N-dimethyl-, inner salt, glycerin, and water increased. The control value was largely increased when 3% of the mixture containing 1-dodecanaminium, N-(carboxymethyl)-N,N-dimethyl-, inner salt, 1-tetradecanaminium, N-(carboxymethyl)-N,N-dimethyl-, inner salt, glycerin, and water was added rather than when 2.6 wt % of the mixture is added, although the difference in weight percent (%) was not large. A more increased amount of the efficacy enhancer is expected to lead to an increase in effect, but as the amount of the efficacy enhancer added is increased, the irritation to eyes becomes severe and material costs may increase. Therefore, the appropriate proportion of an efficacy enhancer added in a product for the tiafenacil and glufosinate-ammonium combination formulation is 3-7 wt %, leading to excellent control values.

### EXAMPLE 7

### Control Values of Samples Containing Tiafenacil-Glufosinate Combination Formulation and Efficacy Enhancers

The control values of samples containing tiafenacil and glufosinate-ammonium combination formulation as an herbicidally active compound and an efficacy enhancer were measured. As for efficacy enhancers, 10 wt % of an alkyl polyglucoside was used as an efficacy enhancer of glufosinate-ammonium, and Alcohols, C₁₂₋₁₄ ethoxylated or Alcohols, C₉₋₁₁ ethoxylated propoxylated as an efficacy enhancer of tiafenacil was added in an amount of 7 wt %, 5 wt %, 3 wt %, and 2.6 wt %, and control samples (Sample Nos. 17 and 18) obtained by adding 5 wt % of polyoxyethylene sorbitan monolaurate were added.

The target weeds Digitaria ciliaris at the 4-leaf stage was treated with the corresponding samples in a spray quantity of 1000 L/ha. Like in a method that is commonly used for evaluating biological activity of an active substance, the efficacy was evaluated as a percent (%) control value by visual rating on 3, 10, and 20 days after treatment. As for visual rating, the control value was set to 100% for complete control of weeds and 0% for no control of weeds.

The measured percent (%) control values are shown in Table 19 below.

TABLE 19
Measurement results of control values of tiafenacil and glufosinate ammonium combination
product according to amount of efficacy enhancer added (Greenhouse test)

| | | | | Control | | |
|---|---|---|---|---|---|---|
| | | | | value(%) at 3, | | |
| | | | | 10, and 20 days | | |
| | | | | after treatment | | |
| | | | Amount of | Digitaria | | |
| | Herbicidally | | active | ciliaris | | |
| | active | | ingredient | 3 | 10 | 20 |
| Sample | compound | Efficacy enhancer (wt%) | (g ai/ha) | DAT | DAT | DAT |
| 1 | Glufosinate- | Alkylpolyglucoside (10%) | 240 + 12 | 90 | 92 | 92 |
| 2 | ammonium | + Alcohols, C12-14 | | | | |
| | + Tiafenacil | ethoxylated (7%) | 480 + 24 | 98 | 99 | 99 |
| 3 | Glufosinate- | Alkylpolyglucoside(10%) | 240 + 12 | 85 | 92 | 91 |
| 4 | ammonium | + Alcohols, C12-14 | | | | |
| | + Tiafenacil | ethoxylated (5%) | 480 + 24 | 96 | 99 | 99 |
| 5 | Glufosinate- | Alkylpolyglucoside(10%) | 240 + 12 | 80 | 82 | 85 |
| 6 | ammonium | + Alcohols, C12-14 | | | | |
| | + Tiafenacil | ethoxylated (3%) | 480 + 24 | 90 | 94 | 95 |
| 7 | Glufosinate- | Alkylpolyglucoside(10%) | 240 + 12 | 70 | 73 | 76 |
| 8 | ammonium | + Alcohols, C12-14 | | | | |
| | + Tiafenacil | ethoxylated (2.6%) | 480 + 24 | 79 | 81 | 83 |
| 9 | Glufosinate- | Alkylpolyglucoside(10%) | 240 + 12 | 87 | 90 | 92 |
| 10 | ammonium | + Alcohols C9-11 | | | | |
| | + Tiafenacil | ethoxylated propoxylated | 480 + 24 | 95 | 98 | 99 |
| | | (7%) | | | | |
| 11 | Glufosinate- | Alkylpolyglucoside(10%) | 240 + 12 | 85 | 88 | 90 |
| 12 | ammonium | + Alcohols C9-11 | | | | |
| | + Tiafenacil | ethoxylated propoxylated | 480 + 24 | 92 | 98 | 97 |
| | | (5%) | | | | |
| 13 | Glufosinate- | Alkylpolyglucoside(10%) | 240 + 12 | 82 | 84 | 88 |
| 14 | ammonium | + Alcohols C9-11 | 480 + 24 | 88 | 90 | 92 |
| | + Tiafenacil | ethoxylated propoxylated | | | | |
| | | (3%) | | | | |
| 15 | Glufosinate- | Alkylpolyglucoside(10%) | 240 + 12 | 71 | 75 | 73 |
| 16 | ammonium | + Alcohols C9-11 | 480 + 24 | 73 | 76 | 78 |
| | + Tiafenacil | ethoxylated propoxylated | | | | |
| | | (2.6%) | | | | |
| 17 | Glufosinate- | Alkylpolyglucoside(10%) | 240 + 12 | 40 | 44 | 51 |
| 18 | ammonium | + Polyoxyethylene sorbitan | | | | |
| | + Tiafenacil | monolaurate (5%) | 480 + 24 | 52 | 56 | 59 |

As shown in Table 19, it can be seen that the control effect was remarkably increased when Alcohols, C₁₂₋₁₄ ethoxylated or Alcohols, C₉₋₁₁ ethoxylated propoxylated as an efficacy enhancer was added to the tiafenacil and glufosinate-ammonium combination product (Sample Nos. 1 to 16) rather than when polyoxyethylene sorbitan monolaurate was added (Sample Nos. 17 and 18). The effects of Alcohols, C₁₂₋₁₄ ethoxylated or Alcohols, C₉₋₁₁ ethoxylated propoxylated were also increased as the active ingredient increased. The control value was largely increased when 3 wt % of Alcohols, C₁₂₋₁₄ ethoxylated and Alcohols, C₉₋₁₁ ethoxylated propoxylated each were added rather than when 2.6 wt % thereof was added, although the difference in weight percent (%) was not large. A more increased amount of the efficacy enhancer is expected to lead to an increase in effect, but as the amount of the efficacy enhancer added is increased, the irritation to eyes becomes severe and material costs may increase. Therefore, the appropriate proportion of an efficacy enhancer added in a product for the tiafenacil and glufosinate-ammonium combination product is 3-7 wt %, leading to an excellent control effect.

What is claimed is:

1. An herbicidal composition comprising:
an herbicidally active compound comprising a pyrimidinedione-based compound; and
an efficacy enhancer for the herbicidally active compound,
wherein the efficacy enhancer is selected from the group consisting of: Alcohols, C₁₂₋₁₄ ethoxylated; Alcohols C₉₋₁₁ ethoxylated propoxylated; a mixture of 1-dodecanaminium, N-(carboxymethyl)-N,N-dimethyl-, inner salt, 1-tetradecanaminium, N-(carboxymethyl)-N,N-dimethyl-, inner salt, glycerine, and water; propylene oxide ethylene oxide polymer octyl ether; organosilicone ethoxylates; polyoxyethylene polyoxypropylene block copolymer; polyoxyethylene alkyl ether; polyoxyethylene polyoxypropylene alkylethers; fatty amine ethoxylates; oxirane, methyl-, polymer with oxirane, mono(2-propylheptyl) ether; quaternary ammonium salt; sodium alkyl sulfosuccinates; polyoxyethylene sorbitanalkylester compounds; methylated soybean oil compounds; ethyl and methyl esters of canola oil; crop oil concentrates; and a combination thereof.

2. The herbicidal composition of claim 1, wherein the pyrimidinedione-based compound is selected from the group consisting of butafenacil, saflufenacil, tiafenacil, benzfedizone, and a combination thereof.

3. The herbicidal composition of claim 1, wherein the herbicidally active compound further comprises at least one selected from the group consisting of glyphosate and glufosinate.

4. The herbicidal composition of claim 1, wherein the herbicidal composition further comprises a surfactant, a solvent, an antifoamer, an antifreezing agent, a thickener, a filler, a pH adjuster, or a preservative.

5. The herbicidal composition of claim 4, wherein the surfactant is selected from the group consisting of: castor oil, ethoxylates; polyoxyethylene tristyrylphenyl ether; ethoxylated fatty alcohol; alkylphenol ethoxylates; ethylene oxide/propylene oxide block copolymer (EO/PO block copolymer); a blend of dodecylbenzenesulfonic acid, calcium salt, and castor oil ethoxylates; polyethylene-polypropylene glycol, monobutyl ether; Alcohols, C₁₂₋₁₅, ethoxylated; methyl methacrylate-methacrylic acid-monomethoxypolyethylene glycol methacrylate copolymer; polyoxyalkylene amine derivative; polyoxyethylene tristyrylphenol phosphate, potassium salt; triethanolamine, compd. with polyoxyethylene) tristyrylphenyl ether; methacrylic acid-methyl methacrylate-polyethylene glycol methyl ether methacrylate copolymer; naphthalenesulfonic acid, polymer with formaldehyde, sodium salt; nonylphenol, ethoxylated, monoether with sulfuric acid, sodium salt; sodium bis(2-ethylhexyl) sulfosuccinate; polyoxyethylene-polyoxypropylene copolymer; [alpha]-D-glucopyranoside, 2-ethylhexyl; phenolsulfonic acid formaldehyde phenol urea polymer, sodium salt; diisobutylnaphthalenesulfonic acid, sodium salt; sucrose monolaurate; poly(oxy-1,2-ethanediyl), alpha-tris(1-phenylethyl)phenyl-omega-hydroxy-phosphate, potassium salt; polyaminoamide alkoxylated condensates; phosphoric acid esters of polyethoxylated tristyryl and distyrylphenol; 2-propenoic acid, 2-methyl-, polymer with butyl 2-propenoate and ethenylbenzene, sodium salt; sulfonic acids, C14-16-alkane hydroxy and C14-16-alkene, sodium salts; lignosulfonic acid, sodium salt; sulfuric acid, disodium salt; acrylic acid polymer, sodium salt; dodecyl sulfate, sodium salt; urea-formaldehyde resin; polyethylene glycol mono(tristyrylphenyl)ether; dodecylbenzenesulfonic acid, calcium salt; sodium stearate; and a combination thereof.

6. The herbicidal composition of claim 4, wherein the solvent is selected from the group consisting of gamma-butyrolactone; N,N-dimethyl decanamide; dimethyl sulfoxide; butyl benzoate; 2-ethylhexyl maleate; 2-ethylhexyl alcohol; propylene carbonate; solvent naphtha (petroleum), heavy aromatic; cyclohexanone; propylene glycol cyclic carbonate; acetophenone; 2-ethylhexyl acetate; lactic acid, ethyl ester; tetrahydrofurfuryl acrylate; and a combination thereof.

7. The herbicidal composition of claim 4, wherein the antifoamer is selected from the group consisting of silicones and siloxanes, dimethyl; siloxanes and silicones, di-Me reaction products with silica; and a combination thereof.

8. The herbicidal composition of claim 4, wherein the thickener is selected from the group consisting of smectite-group minerals; silicon dioxide; magnesium oxide; Fuller's earth; xanthan gum; carboxymethyl cellulose; cellulose, 2-hydroxyethyl ether; gum arabic; acrylic acid polymer; and a combination thereof.

9. The herbicidal composition of claim 4, wherein the filler is selected from the group consisting of potassium chloride; diatomaceous earth, flux-calcined; diatomaceous earth, calcined; kaolin; bentonite; urea; talc; diatomaceous earth (less than 1% crystalline silica); water; and a combination thereof.

10. The herbicidal composition of claim 4, wherein the pH adjuster is selected from the group consisting of sodium hydroxide; potassium hydroxide; phosphoric acid; citric acid; EDTA-acid; and a combination thereof.

11. The herbicidal composition of claim 4, wherein the antifreezing agent is selected from the group consisting of propylene glycol; ethylene glycol; glycerine; 2,3-butandiol; and a combination thereof.

12. The herbicidal composition of claim 4, wherein the preservative is selected from the group consisting of 3(2H)-isothiazolone, 5-chloro-2-methyl; 3(2H)-isothiazolone, 2-methyl; 1,2-benzisothiazolin-3-one; and a combination thereof.

13. The herbicidal composition of claim 1, wherein the efficacy enhancer is contained in an amount of 3-20 wt % on the basis of 100 wt % of the entire composition.

14. The herbicidal composition of claim 1, wherein the herbicidal composition is in a formulation of a wettable powder (WP), an emulsifiable concentrate (EC), Emulsions, oil in water (EW), a microemulsion (ME), a soluble concentrate (SL), water-dispersible granule (WG), or a suspension concentrate (SC).

15. An herbicidal composition, comprising:
an herbicidally active compound comprising tiafenacil; and
an efficacy enhancer comprising, on the basis of 100 wt % of the entire composition, 14-20 wt % of Alcohols, C₁₂₋₁₄ ethoxylated or Alcohols, C₉₋₁₁ ethoxylated propoxylated.

16. An herbicidal composition, comprising:
an herbicidally active compound comprising tiafenacil and glufosinate; and
an efficacy enhancer comprising, on the basis of 100 wt % of the entire composition, 3-7 wt % of Alcohols, C₁₂₋₁₄ ethoxylated or Alcohols, C₉₋₁₁ ethoxylated propoxylated.

17. An herbicidal composition, comprising:
an herbicidally active compound comprising tiafenacil and glyphosate; and
3-7 wt % of an efficacy enhancer on the basis of 100 wt % of the entire composition,
wherein the efficacy enhancer comprises a mixture of 1-dodecanaminium, N-(carboxymethyl)-N,N-dimethyl-, inner salt, 1-tetradecanaminium, N-(carboxymethyl)-N,N-dimethyl-, inner salt, glycerine, and water.
